(19) United States
(12) Patent Application Publication
(10) Pub. No.: US 2018/0345533 A1
(43) Pub. Date: Dec. 6, 2018

(54) MOBILE THREE-DIMENSIONAL PRINTER WITH LAYER SMOOTHING

(71) Applicant: Cazza Inc., Saratoga, CA (US)

(72) Inventors: Javier Hernandez, Lappeenranta (FI); Christopher Priess Kelsey, San Francisco, CA (US); Fernando De Los Rios, Saratoga, CA (US)

(21) Appl. No.: 15/662,761

(22) Filed: Jul. 28, 2017

Related U.S. Application Data
(60) Provisional application No. 62/513,404, filed on May 31, 2017.

(51) Int. Cl. B28B 13/02; B28B 1/00; B28B 15/00; B33Y 30/00

(52) U.S. Cl. CPC B28B 13/0295; B33Y 30/00; B28B 15/002; B28B 1/001

(57) ABSTRACT

Disclosed are various embodiments of a mobile 3D printer layer smoothing apparatus. The apparatus utilizes a plurality of heads, the surfaces of which are coupled at their adjacent edges. The surfaces are collectively utilized to apply cosmetic features to extruded material(s), such as concrete, by manipulating the heads and applying pressure to the extruded material(s). The surfaces of each head are coupled to a joint movably coupled to a linear actuator. The operation of the linear actuators causes the heads to change position and/or orientation along flexible couplings between adjacent edges of adjacent surfaces. The apparatus may be integrated into a stand-alone, single-purpose device or integrated into a multi-purpose 3D printing machine, such as a mobile 3D printer device.

### CLAIM OF PRIORITY

This application claims priority to U.S. Provisional Patent Application Ser. No. 62/513,404, filed May 31, 2017, the entire disclosure of which is hereby expressly incorporated by reference herein.

### FIELD OF TECHNOLOGY

This specification relates generally to three-dimensional printers. More particularly, the disclosure pertains to a mobile three-dimensional printer.

### BACKGROUND

Three-dimensional (3D) printers have penetrated numerous industries and assumed various form factors to suit various purposes and scale according to market supply and demand. While 3D printers thrive as prototyping tools for hobbyists, makers, and engineers, there is a need for 3D printers that are suited for large-scale projects, especially in the construction industry. However, a scaled up gantry-based 3D printer is impractical for extruding buildings. To be used for constructing building, gantry-based 3D printers take up an enormous amount when set up on-site and are difficult to expand if needed. As such, gantry-based 3D printers are usually used to prefabricate the building or parts thereof. These ‘prefabs’ must be shipped individually and assembled manually at the construction site. Although this effectively enables the use of 3D printed, parametrically modeled structures, the process of transporting and assembling prefabs is an expensive, error-prone, and labor-intensive procedure. Furthermore, buildings constructed this way do not gain the unique structural benefits of building extruded all at once at their final destination.

Current mobile 3D printers for construction have numerous shortcomings, such as poor stability measures, limited vertical clearance, limitations to specific types of extruded materials, and lack of smoothing features. A current mobile 3D printer for aiding construction is the RC 3DP by CyBe Construction (www.cybe.eu), which utilizes continuous tracks to move freely in a construction site. However, RC 3DP requires a flat, level surface to work properly, as its elevation system cannot compensate for uneven surfaces. Furthermore, programming and operating the RC 3DP requires skilled labor with knowledge in robotics equipment. The RC 3DP is also controlled via cable, which is an additional potential point of failure for the system. Also, current mobile printer construction generally requires significant manual post-extrusion work, for example, to apply reinforcement structures such as rebar, or to make cosmetic changes to the extruded surfaces.

Thus, there exists a need for a mobile 3D printer that combines the benefits of current fused deposit modeling machines with a mobile platform that provides Internet of Things (IoT) integration, intuitive UX/UI design and programming, superior stability, vertical clearance, remote control, and smoothing features for construction projects of any scale.

### SUMMARY

In accordance with the foregoing objectives and others, exemplary mobile 3D printing devices and systems are disclosed herein. The described embodiments describe an arrangement of electromechanical devices executing instructions to provide solutions to the above deficiencies in the prior art.

In one aspect, an apparatus comprises a plurality of heads, each head comprising a joint coupled to a rigid plate. The heads are spatially arranged such that the rigid plates of adjacent heads are directly or indirectly flexibly coupled. Thus, the rigid plates of the plurality of heads collectively create a continuous surface.

The apparatus may also comprise one or more linear actuators. Each linear actuator may comprise a first end movably coupled to the joint of a corresponding head. Operation of the one or more linear actuator(s) may cause one or more corresponding head(s) to change a position and/or orientation relative to other heads by pivoting around adjacent edges between adjacent rigid plates. The apparatus may also comprise a covering disposed on the rigid plates and coupled to the edges thereof. The covering may be substantially made of a flexible, high-density material, such as rubber, and may be adhered to the rigid plates.

In another aspect, a system comprises a plurality of heads, each comprising a joint coupled to a rigid plate. The heads are spatially arranged such that the rigid plates of adjacent heads are directly or indirectly flexibly coupled. Thus, the rigid plates of the plurality of heads collectively create a continuous surface.

The system may also comprise one or more linear actuators. Each linear actuator may comprise a first end movably coupled to the joint of a corresponding head. Operation of the one or more linear actuator(s) may cause one or more corresponding head(s) to change a position and/or orientation relative to other heads by pivoting around adjacent edges between adjacent rigid plates. The apparatus may also comprise a covering disposed on the rigid plates and coupled to the edges thereof. The covering may be substantially made of a flexible, high-density material, such as rubber, and may be adhered to the rigid plates.

### BRIEF DESCRIPTION OF THE DRAWINGS

The embodiments of this invention are illustrated by way of example and not limitation in the figures of the accompanying drawings, in which like references indicate similar elements and in which:

FIG. 1 shows a block diagram of an exemplary mobile 3D printer.

FIG. 2 shows a block diagram of an exemplary printer-server network configuration.

FIG. 3 shows an exemplary mobile 3D printer.

FIGS. 4A-B respectively show a perspective view and a right view of an exemplary robotic arm assembly of the mobile 3D printer.

FIG. 4C shows a telescopic arm and a printing head of the robotic arm assembly.

FIG. 5A shows a layer smoothing mechanism of the printing head.

FIG. 5B-C respectively show a side view of a smoothing head and a schematic of a dynamic smoothing surface comprising multiple smoothing heads.

FIGS. 6A-C respectively show perspective, bottom, and right-side views of an exemplary attachment interface.

Other features of the present embodiments will be apparent from the accompanying drawings and from the detailed description that follows.

### DETAILED DESCRIPTION

Various mobile three-dimensional printers and components thereof are disclosed herein that are adapted to provide aid on a construction site of any size or scope by, for example, autonomously extruding an extrudable material, such as concrete, in layers. A mobile 3D printer is advantageous over conventional building methods requiring manual labor, which are inefficient generally due to excessive waste and misallocated resources and generate an inferior product compared to the method of 3D-printing structures.

The various embodiments of the mobile 3D printer described herein offer numerous advantages over the prior art. For example, various embodiments of the mobile 3D printer described herein provide seamless integration of construction tools incorporating CAD and parametric modeling software, stability improvements, remote control and autonomous operation, a user-friendly UI/UX, interchangeable printing nozzles, and layer smoothing features to provide solutions to the above-discussed disadvantages of the known prior art. These solutions drastically reduce the amount of human labor needed on a construction site, efficiently utilize building materials, reduce construction time, and prevent the need to transport and assemble pre-fabricated portions of a construction project.

“Construction asset” refers to one or more digital files comprising instructions that can be processed by CAM software executed by a data processing device (e.g., the mobile 3D printer, the server, and/or the client device described herein) to construct a physical representation of one or more 3D models, usually in layers. When executed, the instructions may allow the user to control the operation of any component(s) of the 3D printer in a sequential and/or parallel manner. The process of parsing the instructions of any construction asset(s) and creating the 3D model(s) stored therein may be referred to herein as ‘building the construction asset.’

‘Attachment interface’ refers to a structural component configured to allow mounting of any mechanical or electromechanical subcomponents and optionally configured to provide electrical power or a suitable actuator to said subcomponents.

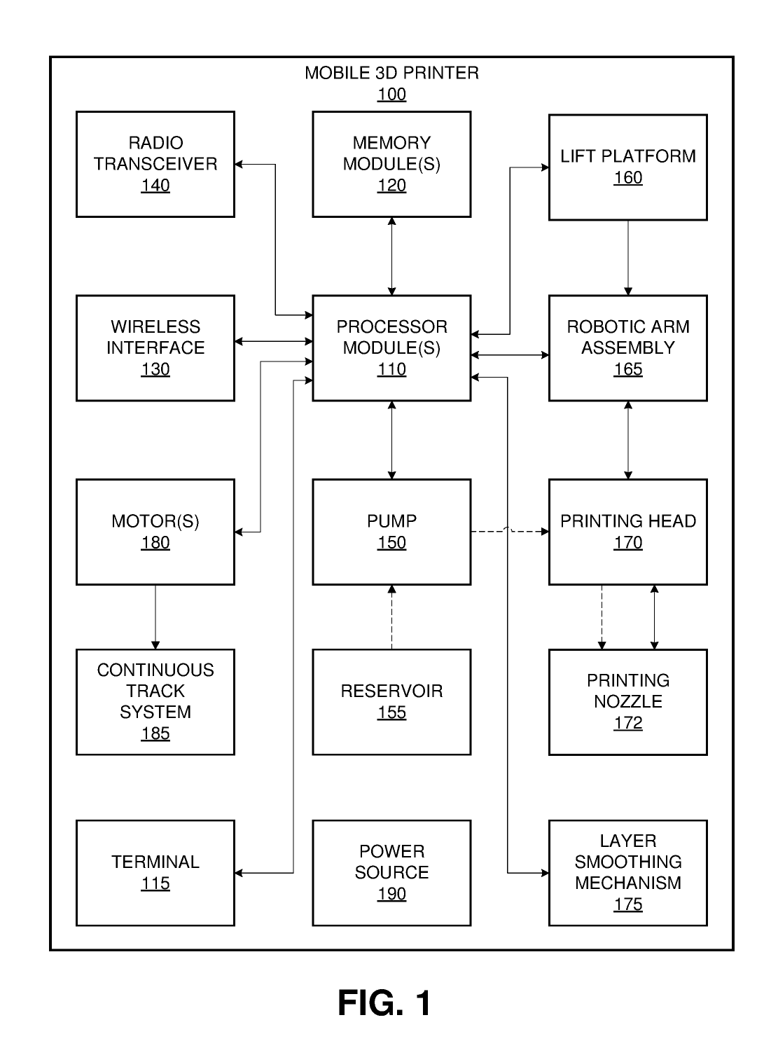

Referring to FIG. 1, a block diagram of an exemplary mobile 3D printer 100 is shown. As shown, the mobile 3D printer 100 comprises one or more processor module(s) 110 (e.g., incorporating one or more CPU(s) and/or one or more GPU(s)), a terminal 115, one or more memory module(s) 120 (e.g., volatile and/or nonvolatile memory), a wireless interface 130, a radio transceiver 140, a pump 150, a reservoir 155, a lift platform 160, a robotic arm assembly 165, a printing head 170, a printing nozzle 172, a layer smoothing mechanism 175, one or more motors 180, a continuous track system 185, and a power source 190. Instead of or in addition to the reservoir 155, the mobile 3D printer 100 may be optionally coupled to a material supply source, such as a concrete mixing transport truck or to an external power supply.

The mobile 3D printer 100 is adapted to execute, through the processor module(s) 110, instructions stored in the memory module(s) 120 to build construction asset(s). Such instructions may be embodied in any appropriate format for computer-aided manufacturing, such as Gcode or any other numerical control programming language.

In some embodiments, the mobile 3D printer 100 is adapted to execute a first set of instructions for manipulating the position and orientation of the robotic arm 165 through a hydraulic system comprising one or more motors 180 of the robotic arm 165 and a second set of instructions for manipulating the position and orientation of the mobile 3D printer 100 through the one or more motors 180 and connected continuous tracks 185. In other embodiments, the above sets of instructions may be combined into one set, i.e., the mobile 3D printer 100 may be adapted to operate the continuous tracks 185 and the robotic arm 165 (and to execute other instructions) simultaneously.

In an additional embodiment, the mobile 3D printer 100 is adapted to execute instructions to activate the pump 150, which pumps extrudable material from the reservoir 155 to the printing head 170, and subsequently to the printing nozzle 172. The path of the extrudable material is shown with unidirectional dashed arrows in FIG. 1. Upon operating the pump 150, positive pressure may be created through a suitable hose directed from the pump 150 to the printing nozzle 172 and a material contained within the reservoir may be pushed through the hose to the printing nozzle 172. The hose may be any hose appropriate for transporting bulk materials such as abrasive slurries. Additionally, the hose may be kinked and/or routed around the robotic arm assembly 165 so as not to interfere with the assembly's freedom of movement.

Though the mobile 3D printer 100 will be described herein as extruding concrete, it will be appreciated by a person of ordinary skill in the art that any extrudable material may be utilized by the mobile 3D printer 100, such as polymers, composites, metals, expandable foam, ceramics, wood, recycled paper mixes, and biopolymers. Although the pump 150 described above is adapted to pump concrete, it can also be adapted to pump any other extrudable material.

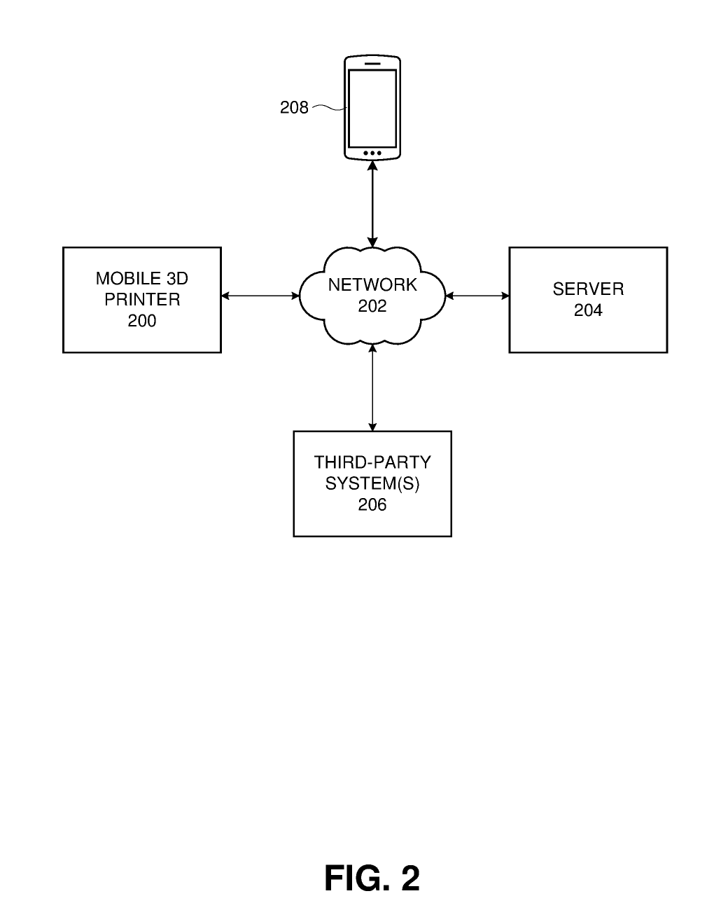

Referring to FIG. 2, a block diagram showing an exemplary printer-server network configuration is shown. In one or more embodiments, the above-described instructions and any other instructions executable by the processor module(s) may be stored in the memory module(s) of the mobile 3D printer 200. In another embodiment, the instructions may be stored in one or more storage device(s) of a server 204 communicatively coupled to the mobile 3D printer 200 through a network 202. One or more processor(s) of the server 204 may execute the stored instructions and communicate machine code instructions to the mobile 3D printer 200, which when executed by the printer, cause the mobile 3D printer 200 to build construction asset(s). The server 204 may also provide a user of the mobile 3D printer 200, the server 204, or a client device 208 the ability to manipulate the mobile 3D printer 200 through, for example, a browser-based application executable by the mobile 3D printer 200, the server 204, or a client device 208. The network may be any wide area network (WAN) such as the Internet or a local area network (LAN) such as Wi-Fi™. Network connectivity may utilize any wireless and/or wired protocol.

In another embodiment, the instructions may be stored in one or more storage device(s) of one or more third-party system(s) 206 communicatively coupled to the mobile 3D printer 200 through the network 202. Generally, the third-party system(s) 206 may be used to access construction assets, other applications for building construction assets, firmware updates, and other data that may facilitate building construction assets using the mobile 3D printer with or without the server 204 and/or the client device 208.

In yet another embodiment, the instructions may be stored in one or more storage device(s) of a client device 208 in the form of an executable application that is adapted to communicate machine-ready instructions to the mobile 3D printer 100 through the network 202. The client device 208 may be a general-purpose computer, such as a desktop, workstation, laptop, tablet, smartphone, or other data processing device incorporating one or more processor(s) and one or more memory module(s). Or the client device may be an ASIC configured to relay Gcode instructions to the mobile 3D printer 200 and allow manual control.

In one embodiment, the one or more third-party system(s) 206 may incorporate, among other modules, a database of construction assets accessible by the user of the mobile 3D printer 200. Upon selecting one or more construction assets, the user may upload said construction asset(s) to the mobile 3D printer 200, which may be utilized by CAM software executed by the mobile 3D printer 200 to generate machine code instructions that when executed by the mobile 3D printer 200 cause the mobile 3D printer 200 to build the construction asset(s).

In one or more embodiments, a construction asset incorporates one or more 3D models. In the case of a plurality of 3D models, the construction asset may also incorporate spacing information (i.e., the distance for the mobile 3D printer 200 to travel) between and orientation of the 3D models. For each construction asset, the mobile 3D printer 200 (or a communicatively coupled server 204 or client device 208) may generate layer-specific instructions, including but not limited to: spatial positioning and orientation of the robotic arm assembly 165 throughout the layer extrusion, spatial positioning and orientation of the mobile 3D printer throughout the layer extrusion, temperature parameters, flow velocity, layer thickness, layer height, and nozzle speed. The layer-specific instructions may also incorporate pauses, which may permit the installation of building components such as electrical wiring, plumbing, and reinforcements if done manually. Additionally, the layer-specific instructions may also comprise surface smoothing instructions and nozzle selection instructions as described herein.

In one or more embodiments, a plurality of mobile 3D printers may execute instructions causing the plurality of mobile 3D printers to work in unison to build one or more construction assets. A plurality of mobile 3D printers used simultaneously drastically reduces construction time, allows for multiple materials to be layered together or on top of each other, and allows for objects (e.g., rebar, stakes) to be placed in a composite layer (e.g., concrete).

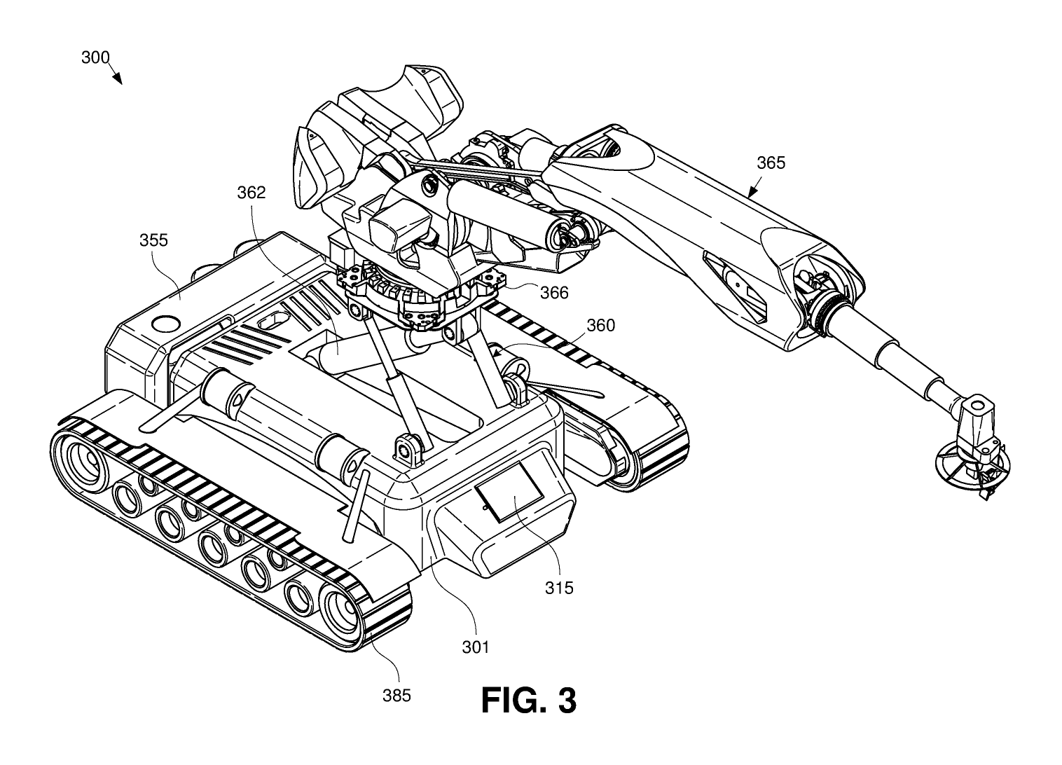

Referring to FIG. 3, an exemplary mobile 3D printer 300 is shown. As shown, the mobile 3D printer 300 comprises a central unit 301, a terminal 315, a continuous track system 385, a reservoir 355, a lift platform 360, and a robotic arm assembly 365.

In one embodiment, the central unit 301 comprises the pump 150, the one or more motors 180, a plurality of electrical components (i.e., the processor module(s) 110, the memory module(s) 120, the wireless interface 130, and the radio transceiver 140), and the power source 190. Sensitive components are best housed within the central unit 301 to reduce points of failure. Furthermore, the weight of the central unit 301 may be adapted to maintain a low center of mass despite the height, reach, and weight of the robotic arm assembly 365.

The pump 150 may be any pump adapted to transport high-density composite materials, such as concrete. In an alternate embodiment, if the material being extruded does not require a pump, the pump 150 may be replaced by an analogous module. For example, if the material being extruded is plastic, a motorized spool may be used in place of the pump 150 to move the plastic toward the nozzle, which may incorporate a heating element and thermistor to regulate the temperature of the nozzle and melt the plastic. It will be appreciated that the mobile 3D printer 300 may be configured to extrude other types of extrudable materials as well.

The one or more motors 180 may be adapted to drive a first set of continuous tracks of the continuous track system 385. Another motor may be used to drive a second set of continuous tracks opposite the first set of continuous tracks. The two sets of continuous tracks may be disposed beside the control unit 301 and may be driven by one or more drive wheels. In a further embodiment, the continuous track system 385 may further comprise idler wheels to maintain tension in the track and return rollers to keep the top track straight. In a preferred embodiment, the one or more motors 180 may be hydraulic motors. A hydraulic motor may be best suited due to its relatively low power consumption. In yet a further embodiment, the continuous track system 385 may further comprise a suspension system that absorbs shock during operation of the mobile 3D printer 300.

The central unit 301 or any other structural component may be configured to tow one or more trailers. The one or more trailers may comprise one or more containers storing various materials for use by the mobile 3D printer 300. For example, the one or more trailers may comprise additional reservoirs for storing and mixing concrete. Or the one or more trailers may comprise a power source that may provide power to any of the components of the mobile 3D printer 300 or other devices. Alternately, the one or more trailers may provide storage for materials used by a supervising technician.

In one embodiment, the central unit 301, the reservoir 355 and/or other component of the mobile 3D printer 300 may comprise one or more trailer attachment points to which a trailer may be hitched. For example, the trailer attachment point may be a hook, ring, or conventional tow hitch.

The reservoir 355 may be adapted to contain a volume of concrete or other extrudable material and, if needed, maintain it in a liquid or semi-liquid state. In one embodiment, the reservoir 355 may comprise one or more spinning cylinders which may continuously mix any contained material to prevent drying. Additionally, the reservoir 355 may further comprise a delivery port through which contained extrudable material may be delivered to the pump 150 through suitable hosing (not shown).

In a preferred embodiment, the reservoir 355 has a 250-liter capacity, which may be suited for relatively small operations. Though the reservoir 355 may be any capacity, it will be noted that a higher capacity reservoir may cause the mobile 3D printer 300 to require a higher-power motor to operate, which may cause the power source to deplete quicker. On the other hand, a larger reservoir allows for less lag time during construction due to less frequent reservoir replacements or refills. Additionally, a larger reservoir maintains a center of mass that is low and nearer to the reservoir, which adds to the stability of the mobile 3D printer 300 and robotic arm assembly 365 and components thereof.

In one embodiment, to offset the need for a higher capacity reservoir, the reservoir 355 may be adapted to be easily removable from the central unit 301 of the mobile 3D printer 300. Thus, when the reservoir 355 is nearly depleted, the user of the mobile 3D printer 300 may be notified in a timely manner so as to prepare a filled reservoir to replace an empty, mounted reservoir. In another embodiment, the reservoir 355 may be powered by an external power source, allowing the spinning cylinders to continue mixing the contents of the reservoir 355 while it is dismounted from the mobile 3D printer 300. In yet a further embodiment, the reservoir 355 may derive power from a photovoltaic cell mounted on the surface of the reservoir 355. The reservoir 355 may also comprise one or more batteries, which may be recharged through a photovoltaic controller coupled to the photovoltaic cell. The reservoir 355 may also provide adequate insulation or aeration as needed based on the contents of the reservoir 355.

In one embodiment, the reservoir 355 may comprise a gauge or sensor adapted to detect a volume of material remaining in the reservoir 355. For example, the material may be detected based on weight. The gauge may be communicatively coupled to the processor module(s) of the mobile 3D printer 300 and may communicate the detected volume to the processor module(s).

In a further embodiment, the processor module(s) may be configured to detect a threshold volume of remaining material and initiate a reloading operation. The reloading operation may involve relocating the mobile 3D printer 300 to a predetermined location, dismounting the reservoir 300 from the central unit 301, and relocating the mobile 3D printer 300 to another predetermined location to mount a filled reservoir to the central unit 301.

In yet another embodiment, the reservoir 355 may be adapted to perform a flush cycle to remove any residue left in the reservoir 355 after the reservoir is emptied (e.g., through regular operation of the mobile 3D printer 300). In another embodiment, the reservoir 355 may comprise a hatch large enough to allow a worker to use a hose to clean the space with pressurized water.

In another embodiment, the reservoir 355 may comprise a hose attachment point to which a pressurized water source may be coupled. The hose attachment point may be, for example, a threaded port to which a hose may be threadedly coupled to create a secure, leak-free fitting. Delivered to the reservoir through the hose, pressurized water may thoroughly remove debris and materials fixed to the interior surfaces of the reservoir 355. In another embodiment, the interior of the reservoir 355 may be sandblasted.

The central unit 301 may also incorporate a terminal 315. In one embodiment, the terminal 315 may be a display screen which may display data associated with operational parameters of the mobile 3D printer 300. Operational parameters may comprise any data associated with the operational status of the mobile 3D printer 300 and may be selected from the group consisting of: operating temperature, flow velocity, a visualization and/or written description of the construction asset(s) currently in construction, a visualization and/or description of the next construction asset(s) to be constructed, system status, wireless connection strength, percentage of construction completed, time remaining, amount of construction material currently consumed, and amount of construction material remaining.

In another embodiment, the terminal 315 may provide a user interface for interacting with the mobile 3D printer 300, such as one or more buttons, a touchscreen, or other input device. The user interface may be used to view other data associated with operation of the mobile 3D printer 300. Additionally, the user interface may be used to pause, abort or resume the operation of the mobile 3D printer 300.

In another embodiment, the user interface may be used to program the mobile 3D printer 300 to initiate construction of one or more construction asset(s), modify the construction of a pending or queued construction asset, undo construction of a construction asset (such as by using a vacuum pipe and pump to return recently deposited material to the reservoir 355), modify a past-built construction asset, or calibrate the mobile 3D printer 300.

Calibrating the mobile 3D printer 300 through the user interface may require the user to provide a starting position from which the mobile 3D printer 300 may orient itself. This can be achieved by manually controlling the movement of the mobile 3D printer 300 through the terminal 315, the server, and/or a client device.

Based on the construction asset(s) to be initiated through the user interface, the processor module(s) may issue a warning through the terminal that the mobile 3D printer 300 will begin operation (e.g., a notification is displayed through the user interface or a sound is played back through a speaker of the terminal 315 or the mobile 3D printer 300). Other warnings may include: instructions for clearing an area around the mobile 3D printer 300, a notice that no material is flowing through the printing nozzle, a notice that the material flow is non-constant, a notice that a particular component or contents thereof of the 3D printer is/are overheating, a warning that connection with the remote terminal is interrupted, or an exception error during software execution. The area around the mobile 3D printer 300 may be based on the selected construction asset(s), user input, a mapping performed by the mobile 3D printer 300, or an aerial mapping of the construction site from a networked unmanned aerial device.

In another embodiment, the terminal 315 may be a removable data processing device. In a further embodiment, the terminal may be communicatively coupled to the processor module(s) through a wired connection (i.e., when the terminal is attached to the central unit as shown in FIG. 3) or through a wireless connection, such as Wi-Fi™ or Bluetooth(R).

In another embodiment, the terminal 315 may comprise one or more joysticks or other suitable control interface(s) which may be used by a user to move the mobile 3D printer 300 (i.e., operate the motors driving the continuous tracks), move the robotic arm 365, operate the pump, operate the printing nozzle, modify the aperture of the printing nozzle, operate the layer smoothing mechanism, or activate an outrigger system of the mobile 3D printer 300. To the extent that the mobile 3D printer 300 utilizes any operational component, the terminal 315 may allow manual control of that operational component to the user.

Additionally, the user may utilize the terminal 315, such as a tablet terminal device, to manually control the operation of the mobile 3D printer either through manual controls involving selectable buttons in a user interface (e.g., including up, down, left, right arrow buttons; DOF joysticks; extrude button) and/or an accelerometer-based RC application providing an interactive user interface. The user interface may provide, e.g., a video preview of the printing nozzle (if the printing nozzle is additionally equipped with a video camera device communicatively coupled to the processor of the mobile 3D printer 300 and/or the terminal 315), tilt steering wheel controls for printer movement (utilizing the accelerometer and/or a gyroscope to detect the position and/or orientation, respectively, of the terminal 315), fine control of robotic arm movement, and extrusion control.

Additionally, the user may utilize the terminal 315 to program a sequence by which the mobile 3D printer 300 operates any of its components according to one or more of above-described control provisions.

In one embodiment, a user-initiated sequence or building of a construction asset may comprise autonomous and/or manual operational phases. During autonomous phases, the mobile 3D printer 300 may operate without user input. During manual phases, the mobile 3D printer 300 may notify the user that user input is required before the mobile 3D printer 300 resumes autonomous operation. During manual phases, the mobile 3D printer 300 may be manually controlled by the user of the mobile 3D printer 300, or building the construction asset may require manual input by a technician. Autonomous operation may resume upon receiving user input or upon detection that user input to building the construction asset has been completed. In one embodiment, the above notification may be displayed through the terminal 315.

The lift platform 360 may incorporate any mechanism for lifting the robotic arm 365 to a height reasonable for construction. The lift platform 360 constitutes one way of translating the printing nozzle in the Z-axis. The lift platform 360 may additionally tilt in a median plane.

Generally, the lift platform 360 may apply upward pressure on a base 366 of the robotic arm 365. In a preferred embodiment, such pressure may be applied through a hydraulic mechanism of the lift platform 360, which affords superior stability and weight capacity. As shown in FIG. 3, one or more linear actuator(s) 362 may apply pressure to a first side of the base 366 and one or more linear actuator(s) 362 may apply pressure to a second side of the base 366, the second side being substantially opposite to the first side. Although fewer linear actuator(s) 362 may reduce the overall lifting strength and stability of the lifting platform 360, the overall weight of the mobile 3D printer 300 may also be reduced. On the other hand, utilizing multiple linear actuator(s) 362 may contribute to stability and rigidity of the robotic arm 365 overall, which is especially important due to the printer's mobility. Although the continuous track system 385 affords a relatively high level of traction, precise positioning and orientating of the robotic arm 365 is a key component of the mobile 3D printer's effectiveness as a primary tool in a construction site.

In another embodiment, the lifting platform 360 may incorporate a single, vertical linear actuator. In yet another embodiment, the lifting platform 360 may be operated through a pneumatic mechanism. A pneumatic system may have similar advantages to a hydraulic system, such as providing a fail-safe option in case of power failure. In another example, a purely mechanical mechanism may be used, such as a lead-screw or a rack-and-pinion mechanism.

In some embodiments, the lifting platform 360 may incorporate a pantograph support structure (a ‘scissor lift’) having any number of linkages to allow the lifting platform 360 to achieve any desired height. Thus, the height attainable by the mobile 3D printer 300, and overall weight thereof, may be adjusted by changing of the number of linkages.

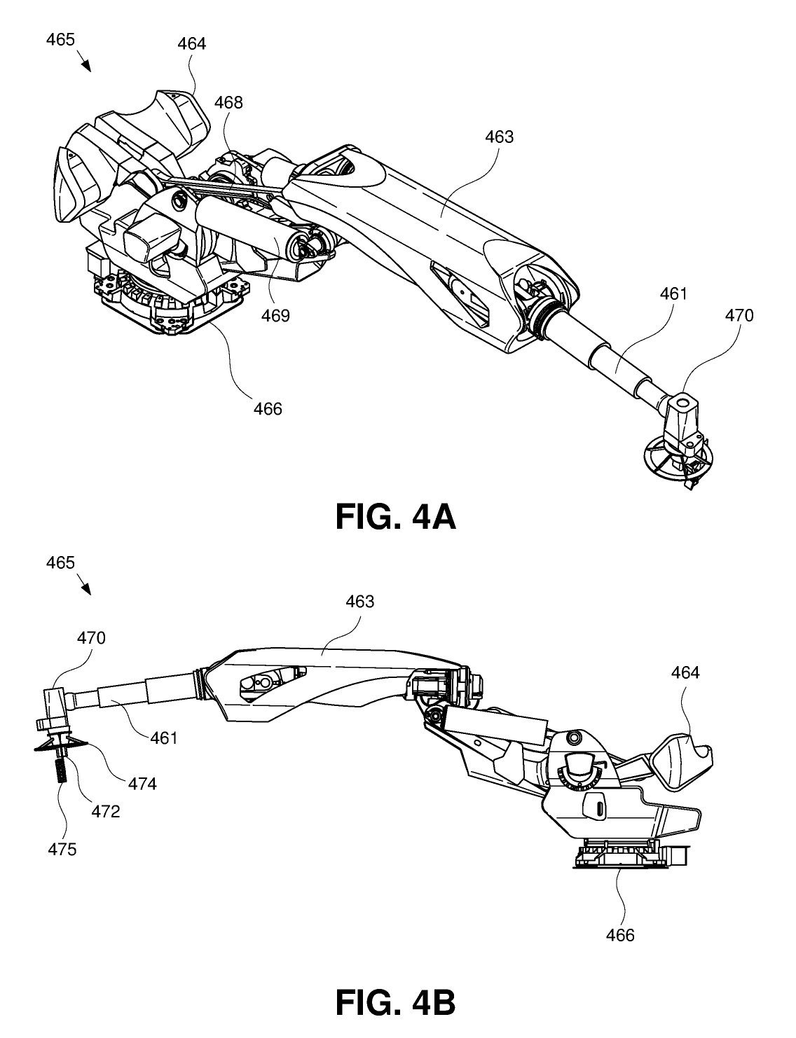

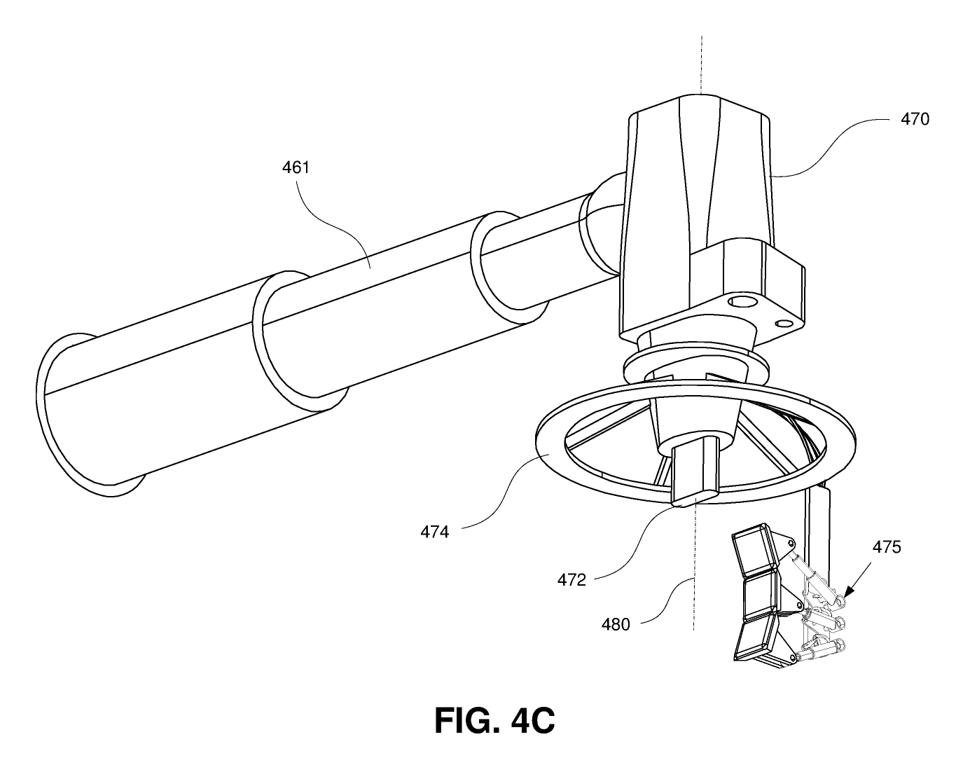

Referring to FIGS. 4A-B, a perspective view and a right view of an exemplary robotic arm assembly 465 are shown respectively. Generally, the robotic arm assembly 465 allows up to 6 degrees of freedom (DOF) along the X, Y, and Z axes and/or in the coronal, median, and transverse planes. Combinations of such movements allow the robotic arm assembly 465 to reach substantially any point in a sphere around the mobile 3D printer. The robotic arm assembly 465 may be coupled to the one or more linear actuator(s) 362 of the lifting platform 360. Or, the robotic arm assembly 465 may be coupled directly to the central unit 301 through the base 466 of the robotic arm assembly 465.

The particular portions of the robotic arm assembly 465 may be mechanically driven by a transmission system that incorporates gear reduction to increase the torque of the robotic arm assembly 465 and improve the precision of the printing nozzle. Properties of the robotic arm assembly 465, such as overall size and gear ratios, may be changed to suit the construction asset being built without reducing the utility of the robotic arm assembly 465.

Reference is made back to FIG. 3. A key component of the mobile 3D printer's efficacy in building a construction asset is its superior stability and control over its position and orientation with or without reference to external objects. The mobile 3D printer 300 achieves this by utilizing substructures and properties thereof that impart a low center-of-mass, provide leverage to enable far reach, utilize a telescoping arm to enable far reach, and utilize a hydraulic motor system throughout that provides high torque and minimizes power usage. Factors that contribute to these advantages include, but are not limited to: the relatively low height of the central unit 301, the wide profile of the mobile 3D printer 300 due to the placement of the continuous track system 385 lateral to the central unit 301, mounting the reservoir 355 behind the central unit 301 and opposite to the printing nozzle, the weight of a ballast 464 being calibrated with the reservoir 355, utilizing a robotic arm assembly 365 with heavier features closer to the center of the mobile 3D printer, and utilizing a suspension system for the continuous track system 385.

In a preferred embodiment, the center of mass of the mobile 3D printer 300 may be substantially between the reservoir 355 and the one or more linear actuator(s) 362. Though the exact center of mass may change based on the weight of reservoir 355, the center of mass generally stays within the space described above to maximize the mobile 3D printer's leverage during a construction project.

Referring back to FIG. 4A, in one or more embodiments, the mobile 3D printer 400 may also comprise a ballast 464 to provide additional leverage for the robotic arm assembly 465. The ballast 464 may be positioned substantially above the mobile 3D printer's center of mass, which is preferably located at a position that most effectively compensates for the weight and reach of the arm. For example, the center of mass may be situated substantially above and/or between the reservoir 355 and the central unit 301. However, it will be appreciated that the center of mass of the mobile 3D printer may be different if the components of the mobile 3D printer are arranged in different positions, utilize different form factors, or are integrated with further components. Generally, the mobile 3D printer provides the ability to customize mass distribution by allowing coupling of one or more weight-variable ballasts to one or more external or internal attachment points of the mobile 3D printer.

As shown in FIG. 4A, the ballast 464 may be adjustably attached to the robotic arm assembly 465 opposite to the printing nozzle 472. In another embodiment, the ballast 464 may be configurable. For example, the ballast 464 may be removable and attachable to other parts of the mobile 3D printer 300. Or, the ballast 464 may be expandable by incorporating attachment points to which supplementary ballast may be coupled. Or the ballast 464 may include a fillable container, e.g., fillable with a fluid (such as water), to manipulate the weight of the ballast 464.

In one or more embodiments, the robotic arm assembly 465 may instead be a crane attachment. The mobile 3D printer may also comprise one or more configurable outrigger legs to provide additional leverage, especially on uneven surfaces. The crane attachment may allow for even further reach and added stability. In another embodiment, the mobile 3D printer 300 may comprise a combination of one or more crane attachments and one or more robotic arm assemblies.

The distribution of weight throughout the mobile 3D printer 300 is one factor contributing to stability. In one or more embodiments, the mobile 3D printer 300 accounts and compensates for vibrations and/or displacements detectable through an accelerometer and gyroscope. If such minor shifts in movement are not detected and accounted for, the tolerance at the printing nozzle 472 may be too high and the minimum viable product (MVP) may not be workable.

In one or more embodiments, the mobile 3D printer 300 may account for vibrations and/or displacement by utilizing an emitter-sensor position and orientation detection system. Such systems may comprise one or more sensor(s) and one or more emitter(s) and the sensor(s) and emitter(s) may utilize infrared (IR) or laser technology. The mobile 3D printer 300 may comprise the sensor(s), which may receive a beam from the emitter(s), which may be positioned in the vicinity of the mobile 3D printer 300. For example, the emitter(s) may be positioned at a high vertical clearance in order to maintain line of sight with the sensor anywhere throughout the construction site. Alternately, the emitter(s) and the sensor(s) may be switched, i.e., the mobile 3D printer 300 may comprise the emitter(s) and one or more external sensor(s) may receive beams from the emitter(s), in which case a microcontroller communicatively coupled to the sensor(s) may communicate sensor data to the mobile 3D printer 300 via a wired or wireless, direct or networked connection.

In another embodiment, one or more long range passive IR or laser reference point(s) (emitter(s) and/or sensor(s)) positioned externally to but in the vicinity of the mobile 3D printer 300 may be utilized by the mobile 3D printer 300 to account for vibration and/or displacement. The external reference point(s) may be used throughout the construction site to consistently calibrate the position and orientation of the mobile 3D printer 300 and/or components thereof throughout building a construction asset. In a preferred embodiment, at least three reference points may be utilized by the mobile 3D printer 300, which may allow the mobile 3D printer 300 to properly triangulate the position of the mobile 3D printer 300 and components thereof with high precision. To account for any detected deviations, the mobile 3D printer 300 may compensate for such deviations by utilizing any number of locomotive or orientating components of the mobile 3D printer 300, including but not limited to the one or more motors 180, the robotic arm assembly 165, the continuous track system 185, the telescoping portions 461, and an attachment interface 474.

In one embodiment, the mobile 3D printer 300 may continuously or periodically correct the motion of the mobile 3D printer 300 by comparing expected position/orientation (e.g., based on executing GCode or other appropriate instructions) with actual position/orientation (e.g., based on sensors within and without the mobile 3D printer 300).

In another embodiment, the mobile 3D printer 300 may compensate for vibrations and/or displacement without reference to an external object, location, or point. The mobile 3D printer 300 may comprise an accelerometer to detect forces acting on the mobile 3D printer 300 or any components thereof and a gyroscope to detect orientation of the mobile 3D printer 300 or any components thereof.

Before commencing a particular construction project, the mobile 3D printer 300 may record a starting location, position and/or orientation and compare movement/orientation data to the starting location position and/or orientation to properly calibrate the mobile 3D printer 300 or any components thereof. The mobile 3D printer 300 may periodically create new reference points throughout the construction project to provide calibration milestones that can be used as reference for further compensation as described above. Although this method may provide a simpler way of compensating for vibrations and displacement, it may be preferred where the construction site is flat or where there may be little to no interference with the printer's operation.

In addition to compensating for vibrations and displacement, the mobile 3D printer 300 may also predict a potential cause of vibration, displacement, or collision by utilizing one or more motion sensors that may monitor the surroundings of the mobile 3D printer 300. The mobile 3D printer 300 may continuously compare motion sensor data to pre-established models to determine potential causes of vibration, displacement, or collision. For example, the mobile 3D printer 300 may detect the presence of a human (based on comparing motion sensor data to one or more established human models) on the construction site and either pause construction or execute additional steps to avoid said human.

In a further embodiment, the mobile 3D printer 300 may be configured to detect the presence of another mobile 3D printer, another device, or a particular human worker in the vicinity by comparing motion sensor data or video camera data (generated by a video camera communicatively coupled to the processor(s) of the mobile 3D printer 300) to preloaded data associated with said printer, device, or worker. For example, the mobile 3D printer 300 may be configured to detect an RFID chip associated with a nearby printer, device or worker. The RFID chip may comprise identification data, the determination of which by the mobile 3D printer may cause the mobile 3D printer to perform operations, such as pause operation, modify queued operation(s), or cancel queued operation(s). In another embodiment, instead of RFID, the mobile 3D printer may utilize sonar, IR, or a laser-based mechanism to detect the presence, type, and/or movement of nearby objects and correct the path of the printing nozzle as needed to maintain a low-tolerance MVP.

The above processes may be configured to detect any type of object and may not only prevent errors during construction but also contribute to safety and loss prevention.

Referring to FIG. 4C, a telescopic arm 461 and a printing head 470 of the robotic arm assembly 465 is shown. The robotic arm assembly 465 may comprise a telescopic arm 461 mounted to the robotic arm midsection 463 of FIGS. 4A-B, which may incorporate a servomotor for rotating the telescopic arm 461 and a linear actuator for extending/retracting the telescoping arm 461. The telescopic arm 461 provides the printing head 470 with superior reach without having to reposition the mobile 3D printer. Although the telescopic arm 461 shown in FIG. 4C may comprise three nested telescoping portions, the telescopic arm 461 may comprise more or fewer telescoping portions.

A printing head 470 may be coupled at the end of the telescopic arm 461. The printing head 470 is generally adapted to couple to the telescopic arm 461, allow interchangeable mounting of printing nozzles 472, and provide mounting locations for other equipment.

In one embodiment, the printing head 470 may comprise an attachment interface 474 around which a layer smoothing mechanism 475 may be directly or indirectly rotatably coupled, i.e., around a vertical axis 480 extending through the printing head 470. In another embodiment, the layer smoothing mechanism 475 may be directly or indirectly coupled to the printing head 470 or the printing nozzle 472.

In one embodiment, the printing nozzle 472 may be detachable and replaceable with a different nozzle. Generally, the printing nozzle used may be adapted to the type of construction project the mobile 3D printer is performing. For example, when laying a foundation of material for a construction asset, a printing nozzle having a wide diameter or long profile may be more appropriate for extruding a large volume of material. In another example, when producing a portion of a construction asset requiring fine detail, a printing nozzle having a narrow diameter may be appropriate. Or, printing nozzles may be interchangeable and may be adapted for extruding different types of materials.

In another embodiment, the printing head 470 and/or the printing nozzle 472 may be adapted to incorporate construction materials, such as rebar, that contribute to the construction asset's rigidity. Other materials, such as chemical admixtures, curing compounds, or bacterial sprays may also be used. For example, the printing head 470 may additionally comprise a worm-drive configured to drive a rebar filament into or around the extruded concrete such that the rebar is integrated into the construction (i.e., covered by the extruded concrete). The rebar may be fed manually from a technician, be located on or around the mobile 3D printer, and/or retrievable by the mobile 3D printer.

In one embodiment, when a construction asset is converted to a sequence of instructions as described above, the instructions may include a step of displaying a notification, through the user interface, that the printing nozzle 472 must be changed before resuming execution of the sequence of instructions. Or, the notification may comprise instructions to perform manual construction steps (e.g., applying rebar).

In another embodiment, the printing nozzle 472 may be adapted to manipulate the size and/or shape of its aperture through, for example, a shutter valve allowing for the diameter of the aperture to vary continuously or discretely. In this embodiment, pausing to change nozzles would not be required as the mobile 3D printer would adjust the printing nozzle 472 dynamically while adjusting flow velocity through the pump. Combining flow diameter control with flow velocity control allows the mobile 3D printer to adapt effectively to the needs of the operation and produce results consistent with the high expectations usually required of conventional construction, but without complicated retooling or extended delays. Such fine control allows for low-tolerance construction and a high quality MVP.

3D printed objects are usually marked by ridges or excess material along the adjacent edges of extruded layers. This phenomenon is even more prevalent in printing projects using concrete or other slurries, which do not dry as fast as PLA or ABS filaments do. Current solutions require a technician to manually smooth the sides of the layers using a concrete trowel, periodically hydrate the material if needed, apply reinforcement to the construction, and perform other miscellaneous tasks.

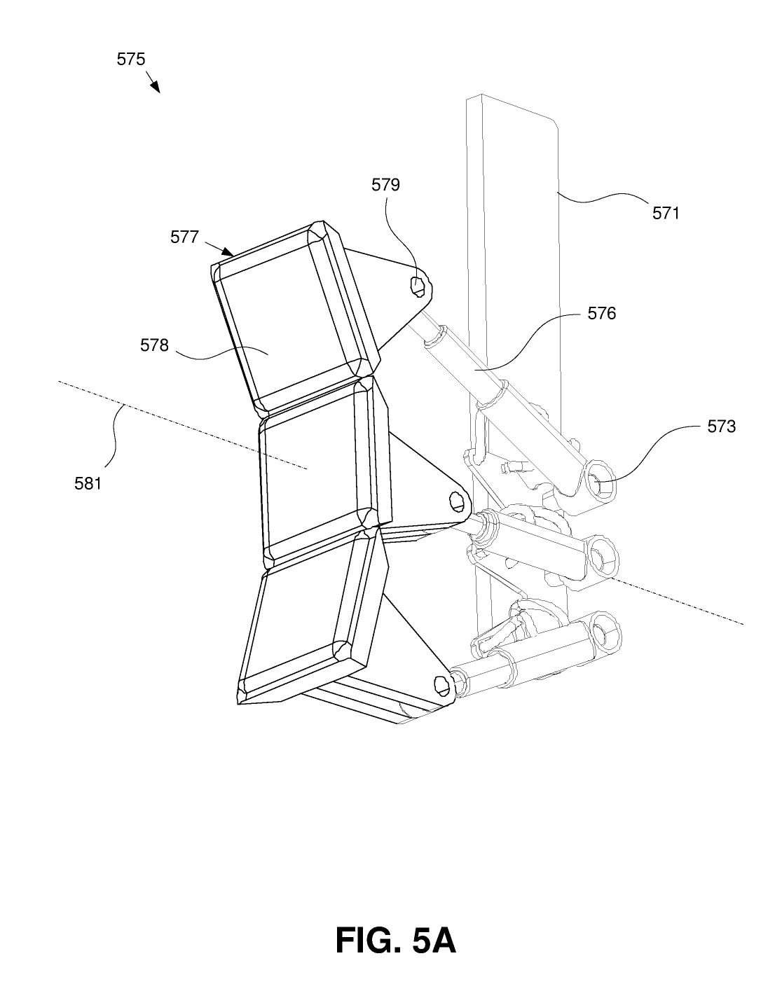

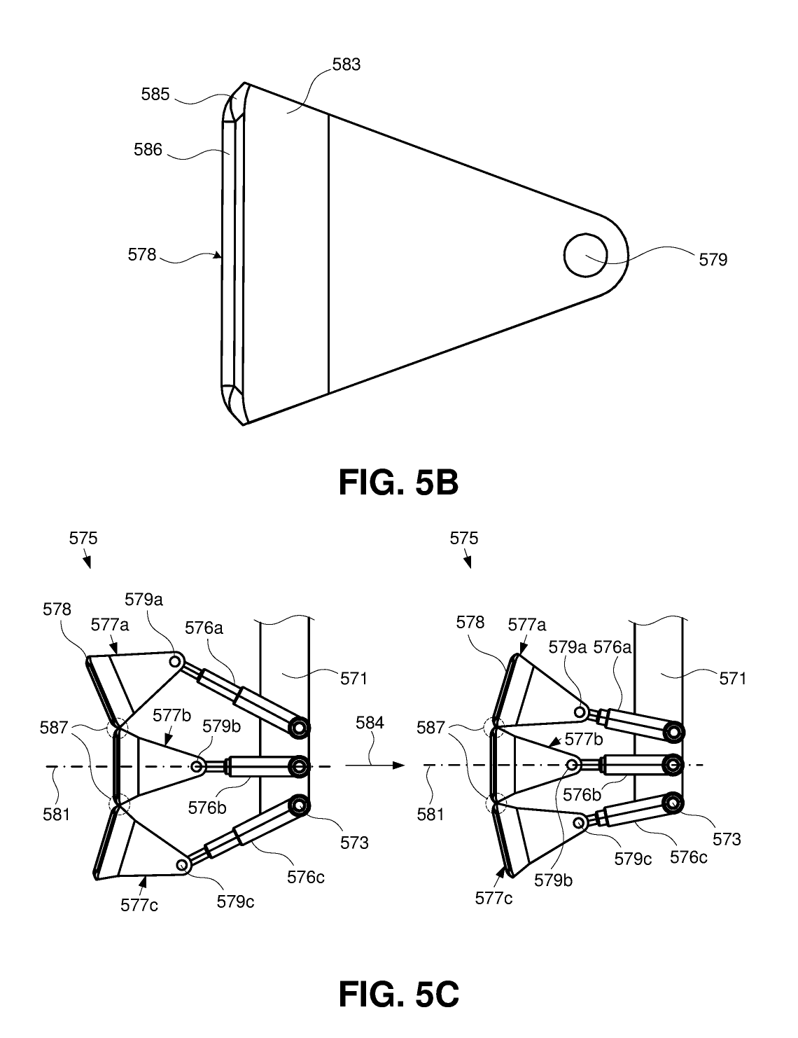

Referring to FIG. 5A, an exemplary layer smoothing mechanism 575 is shown. Generally, the layer smoothing mechanism 575 provides a dynamic smoothing surface that comprises discrete, configurable units that can be individually manipulated to alter the topography of the dynamic smoothing surface. Thus, the layer smoothing mechanism allows the mobile 3D printer to smooth out ridges of excess material that are deposited between layers of semi-liquid material and/or apply a particular contour to said layers by urging the smoothing surface against said layers during building of a construction asset.

In one embodiment, the layer smoothing mechanism 575 comprises one or more smoothing heads 577. The smoothing heads 577 may each comprise a smoothing surface 578 coupled directly or indirectly to a joint 579. In an embodiment incorporating multiple smoothing heads 577 as shown in FIG. 5A, the smoothing heads 577 may be detachably coupled along adjacent edges of the smoothing surfaces 578. Furthermore, each of the smoothing heads 577 may be movable by a linear actuator 576 coupled to its respective joint 579. Each linear actuator 576 may be fixed to a backplate 571 which may be subsequently coupled to any other surface or device in which the layer smoothing mechanism 575 is to be integrated. For example, the backplate 571 may be coupled to the attachment interface 474.

Referring to FIGS. 5B-C, a side view of a smoothing head and a schematic of a dynamic, continuous smoothing surface comprising multiple smoothing heads are respectively shown.

As shown in FIG. 5B, the smoothing head 577 comprises a rigid plate 583 which may comprise a smoothing surface 578. The smoothing surface 578 may simply be the outer surface of the rigid plate 583, or may comprise a coating, covering, or other flexible, high-density material 586, such as rubber. The smoothing surface 578 may taper toward the edges of the smoothing surface 578 overall and/or the edges of particular rigid plates 583. The tapering allows the smoothing surfaces 578 of adjacent smoothing heads to pivot in a wide range around their coupled edges. Thus, the smoothing surface 578 for multiple smoothing heads 577 may be cut from a single sheet of flexible, high-density material having thinner sections disposed toward the edges of the rigid plates 583 and thicker sections disposed toward the center of the rigid plates 583.

In another embodiment, the smoothing surface 578 may comprise a flexible covering 586 having portions coupled to the edges 585 of the rigid plate 583. The space between the covering 586 and the rigid plate 583 may be filled with a material such that the smoothing surface 576 is firm, but flexible. The material may be densely compacted throughout, but may be thinner at the edges 585 of the rigid plate 583 and thicker toward the center of the rigid plate 583. The covering 586 may be a continuous covering that covers the rigid plates 583 of all smoothing heads 577, but is stitched closely to the rigid plates at adjacent edges of adjacent smoothing heads 578. In another embodiment, the adjacent edges of adjacent smoothing heads 577 may be coupled through a hinge, in which case the covering 586 may be configured to cover the hinge.

As shown in FIG. 5C, one or more of the linear actuators 576a-c may undergo a manipulation 584, causing one or more of the smoothing heads 577a-c to pivot around adjacent edges 587 and cause a deformation in the overall smoothing surface created by smoothing heads 577a-c as shown. The linear actuators 576a-c may be fixed at a fixed joint on the backplate 571 (e.g. joint 573), which provides leverage for pivoting the smoothing heads 577a-c around adjacent edges 587 by pushing/pulling the smoothing heads 577a-c at their respective joints 579a-c. Adding further smoothing heads 577 to the layer smoothing mechanism 575 provides for a larger overall smoothing surface and a more configurable topography. Manipulation of this dynamic topography is made possible by pushing/pulling the smoothing heads 577 at their respective joints 579 and causing them to pivot around coupled adjacent edges 587 between adjacent smoothing heads 577.

Though FIGS. 5A-C show a layer smoothing mechanism 575 with smoothing heads 577 arranged vertically, it will be appreciated that the layer smoothing mechanism 575 may comprise one or more smoothing heads 577 of any size or shape and arranged in any physical configuration as long as the smoothing heads are rotatably coupled around their edges. Thus, the layer smoothing mechanism(s) shown in the drawings are to be interpreted in an illustrative, not a restrictive sense.

The layer smoothing mechanism 575 embodiments may be applied to the mobile 3D printer or may be incorporated into a separate mobile layer smoothing device. In any case, the layer smoothing mechanism 575 utilizes a physical structure that provides structural support in addition to one or more orienting mechanisms that allow the entire layer smoothing mechanism 575 to be repositioned and/or reoriented relative to the printing nozzle 572.

The smoothing surfaces 578 of the layer smoothing mechanism 575 may be manipulated to conform to any desired contour. The smoothing surface 578 of the smoothing heads 577 may be flat, curved, or exhibit any regular or irregular surface topology as needed for building a construction asset. For example, the smoothing heads 577 may be manipulated to create any contour having: one or more flat portions with an inclination of about +45 degrees to about −45 degrees from the horizontal axis 581 and/or one or more curved portions. The contour of the collective smoothing surfaces 578 may conform to a curved surface having a minimum radius of about 1 meter and may be either convex or concave relative to the curved surface.

Referring back to FIG. 4C, in one embodiment, the layer smoothing mechanism 475 or any other attachment to the printing head 470 may be rotated around any axis (e.g., vertical axis 480) or translated within any plane. Generally, this manipulation allows the layer smoothing mechanism 475 to be suitably positioned around the printing nozzle 472 such that the layer smoothing mechanism 475 is able to apply cosmetic features to or smooth the sides of layers of extruded material at a wide range of angles. As such, the layer smoothing mechanism 475 may incorporate at least two DOF (manipulation of the smoothing surfaces as described above and movement/reorienting of the entire layer smoothing mechanism 475 as described below) in addition to the typical six DOF of the robotic arm assembly.

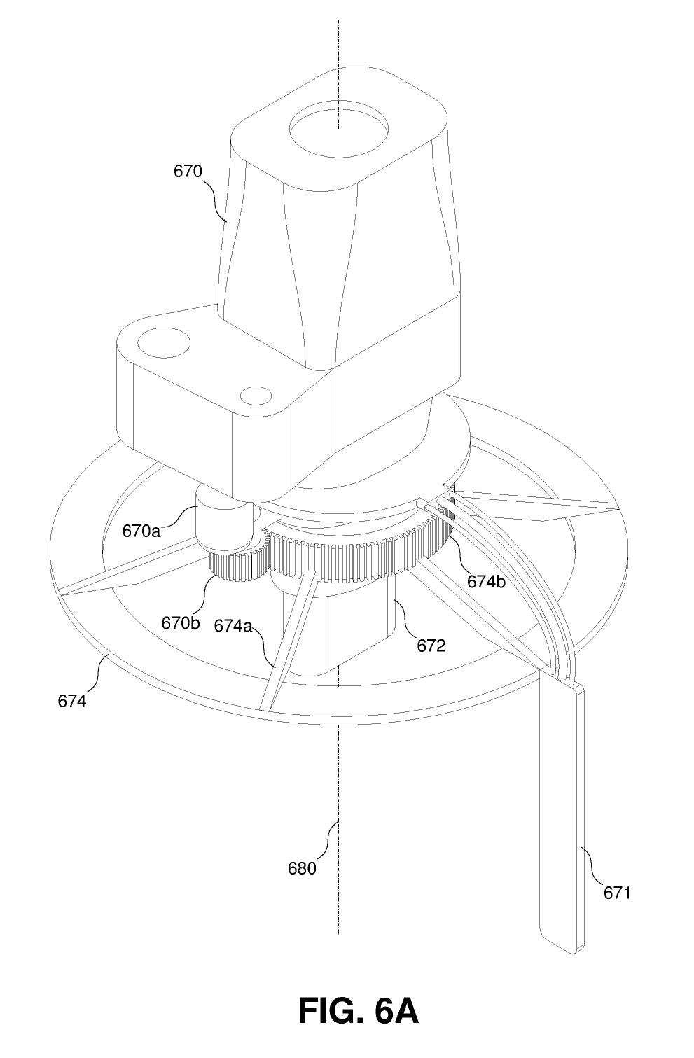

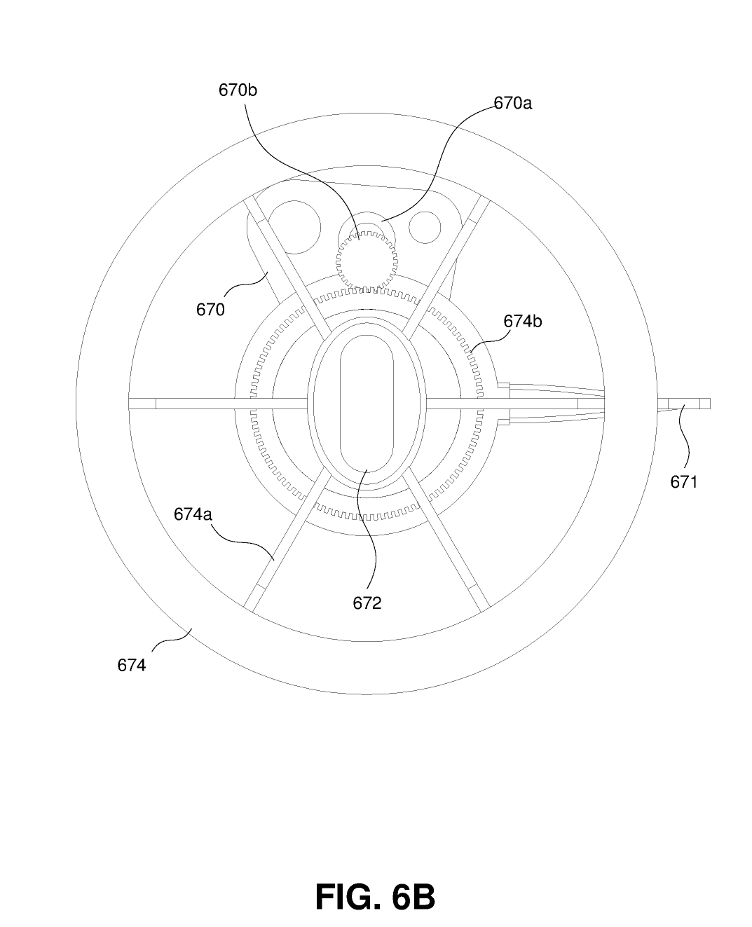

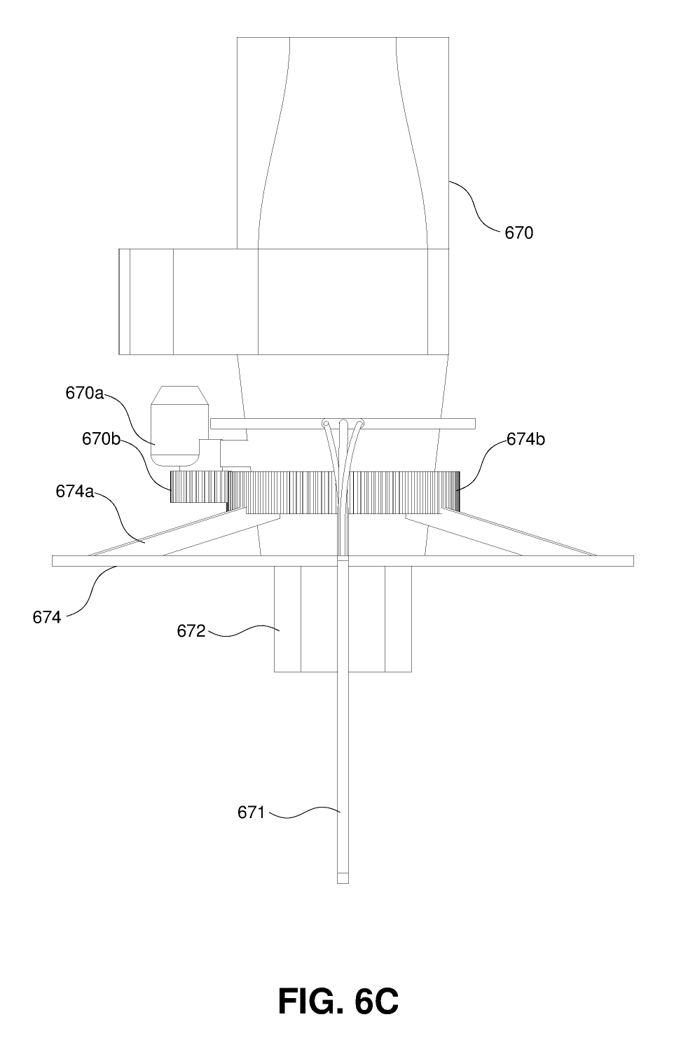

Referring to FIGS. 6A-C, perspective, bottom, and right-side views of an exemplary attachment interface 674 are shown, respectively. The attachment interface 674 allows mounting of the layer smoothing mechanism 675 or other subcomponents that would be utilized during the building of a construction asset.

The attachment interface 674 may conform to any size or shape suitable for providing attachment points for mechanical and/or electrical subcomponents. In one embodiment, the attachment interface 674 may comprise a ring as shown in FIGS. 6A-C. The ring may be coupled to one or more elongated members 674a, which may be subsequently coupled to a transmission gear 674b. The elongated members 674a may extend away from or within a plane also containing the ring. The ring may be additionally configured to be rotatable around the printing nozzle 672.

In one embodiment, the attachment interface 674 may be adapted to change position and/or orientation through an intrinsic actuator or an external actuator. For example, the printing head 670 may comprise an actuator 670a which may be configured to drive a drive gear 670b, which is trained to drive the transmission gear 674b, thus causing the attachment interface 674 to rotate in place, i.e., around the vertical axis 680 extending through the printing head 670. The gear ratio between the drive gear 670b and the transmission gear 674a may be configured for high speed or high torque, depending on the needs of the subcomponents mounted on the attachment interface 674. For example, the layer smoothing mechanism may require a higher gear ratio to generate higher torque, e.g., for carving inlays, or a low gear ratio for high-speed removal of excess material using the above-described layer smoothing mechanism 475. In a further embodiment, the above gear-actuator mechanism may be housed within the printing head 670, i.e., not visible as shown in FIGS. 6A-C. This may prevent corrosion and maintain low-tolerance mechanical operation.

In another embodiment, the ring 674 may incorporate a face gear either covering, both sides, one side, or any portions thereof. The attachment interface 674 may be held in place within the printing head 670, which threaded portions may feed into an aperture of the printing head 670 and be acted upon by an actuator disposed in the printing head 670 and adapted to drive the attachment interface 674. The action of the actuator may cause the threaded portions of the face gear to be driven in a curved path through the printing head 670, and circularly around the printing nozzle 672. Other actuator systems beside gear couplings may be used and are within the scope of the embodiments described herein.

In another embodiment, the attachment interface 674 may be static, i.e., fixed to the printing head 670 and subcomponents of the attachment interface 674 may be configured to locomote along the attachment interface 674. For example, the attachment interface 674 may incorporate teeth or a threaded surface that may allow an actuator of a subcomponent or an actuator of the printing head 670 to drive the subcomponent along any such portion of the attachment interface 674.

In another embodiment, a separate mobile device may be analogous to the mobile 3D printer but lack the 3D-printing capabilities and its heavy-duty constraints. The mobile device may incorporate a subset of the mobile 3D printer's capabilities, such as the layer smoothing mechanism as described above. As such, one or more layer smoothing device(s) may be used to accompany the mobile 3D printer and fulfill a variety of cosmetic or utilitarian purposes during building of a construction asset. Any combination of mobile device incorporating any number and type of features may be used in concert with the mobile 3D printer.

Various embodiments are described in this specification, with reference to the detailed discussed above, the accompanying drawings, and the claims. Numerous specific details are described to provide a thorough understanding of various embodiments. However, in certain instances, well-known or conventional details are not described in order to provide a concise discussion. The figures are not necessarily to scale, and some features may be exaggerated or minimized to show details of particular components. Therefore, specific structural and functional details disclosed herein are not to be interpreted as limiting, but merely as a basis for the claims and as a representative basis for teaching one skilled in the art to variously employ the embodiments. In this regard, directional terminology, such as “vertical,” “horizontal,” “top,” “bottom,” “front,” “back,” “left,” “right,” etc., is used with reference to the orientation of the drawing(s) being described. Because components of the embodiments can be positioned in a number of different orientations, the directional terminology is used for purposes of illustration and is in no way limiting.

The embodiments described and claimed herein and drawings are illustrative and are not to be construed as limiting the embodiments. The subject matter of this specification is not to be limited in scope by the specific examples, as these examples are intended as illustrations of several aspects of the embodiments. Any equivalent examples are intended to be within the scope of the specification. Indeed, various modifications of the disclosed embodiments in addition to those shown and described herein will become apparent to those skilled in the art, and such modifications are also intended to fall within the scope of the appended claims.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

All references including patents, patent applications and publications cited herein are incorporated herein by reference in their entirety and for all purposes to the same extent as if each individual publication or patent or patent application was specifically and individually indicated to be incorporated by reference in its entirety for all purposes.

It will be apparent to one of ordinary skill in the art that, in certain embodiments, any of the functionality of a client may be incorporated into the server, and vice versa. Likewise, any functionality of a client application may be incorporated into a browser-based client, and such embodiments are intended to be fully within the scope of this disclosure. For example, a browser-based client application could be configured for offline work by adding local storage capability, and a native application could be distributed for various native platforms via a software layer that executes the browser-based program on the native platform.

Embodiments of the subject matter and the functional operations described in this specification can be implemented in one or more of the following: digital electronic circuitry; tangibly-embodied computer software or firmware; computer hardware, including the structures disclosed in this specification and their structural equivalents; and combinations thereof. Such embodiments can be implemented as one or more modules of computer program instructions encoded on a tangible non-transitory program carrier for execution by, or to control the operation of, data processing apparatus (i.e., one or more computer programs). Program instructions may be, alternatively or additionally, encoded on an artificially generated propagated signal (e.g., a machine-generated electrical, optical, or electromagnetic signal) that is generated to encode information for transmission to suitable receiver apparatus for execution by a data processing apparatus. And the computer storage medium can be one or more of: a machine-readable storage device, a machine-readable storage substrate, a random or serial access memory device, and combinations thereof.

As used herein, the term “data processing device” or “data processing apparatus” comprises all kinds of apparatuses, devices, and machines for processing data, including but not limited to, mobile 3D printer 100, server 204, client device 208, a programmable processor, a computer, and/or multiple processors or computers. Exemplary apparatuses may include special purpose logic circuitry, such as a field programmable gate array (“FPGA”) and/or an application specific integrated circuit (“ASIC”). In addition to hardware, exemplary apparatuses may comprise code that creates an execution environment for the computer program (e.g., code that constitutes one or more of: processor firmware, a protocol stack, a database management system, an operating system, and a combination thereof).

The term “computer program” may also be referred to or described herein as a “program,” “software,” a “software application,” a “module,” a “software module,” a “script,” or simply as “code.” A computer program may be written in any form of programming language, including compiled or interpreted languages, or declarative or procedural languages, and it can be deployed in any form, including as a standalone program or as a module, component, subroutine, or other unit suitable for use in a computing environment. Such software may correspond to a file in a file system. A program can be stored in a portion of a file that holds other programs or data. For example, a program may include one or more scripts stored in a markup language document; in a single file dedicated to the program in question; or in multiple coordinated files (e.g., files that store one or more modules, sub programs, or portions of code). A computer program can be deployed and/or executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, such as but not limited to an FPGA and/or an ASIC.

Computers suitable for the execution of the one or more computer programs include, but are not limited to, general purpose microprocessors, special purpose microprocessors, and/or any other kind of central processing unit (“CPU”). Generally, CPU will receive instructions and data from a read only memory (“ROM”) and/or a random access memory (“RAM”). The essential elements of a computer are a CPU for performing or executing instructions and one or more memory devices for storing instructions and data. Generally, a computer will also include, or be operatively coupled to receive data from or transfer data to, or both, one or more mass storage devices for storing data (e.g., magnetic, magneto optical disks, and/or optical disks). However, a computer need not have such devices. Moreover, a computer may be embedded in another device, such as but not limited to, a mobile telephone, a personal digital assistant (“PDA”), a mobile audio or video player, a game console, a Global Positioning System (“GPS”) receiver, or a portable storage device (e.g., a universal serial bus (“USB”) flash drive).

Computer readable media suitable for storing computer program instructions and data include all forms of nonvolatile memory, media and memory devices. For example, computer readable media may include one or more of the following: semiconductor memory devices, such as erasable programmable read-only memory (“EPROM”), electrically erasable programmable read-only memory (“EEPROM”) and/or and flash memory devices; magnetic disks, such as internal hard disks or removable disks; magneto optical disks; and/or CD ROM and DVD-ROM disks. The processor and the memory can be supplemented by, or incorporated in, special purpose logic circuitry.

To provide for interaction with a user, embodiments may be implemented on a computer having any type of display device for displaying information to a user. Exemplary display devices include, but are not limited to one or more of: projectors, cathode ray tube (“CRT”) monitors, liquid crystal displays (“LCD”), light-emitting diode (“LED”) monitors and/or organic light-emitting diode (“OLED”) monitors. The computer may further comprise one or more input devices by which the user can provide input to the computer. Input devices may comprise one or more of: keyboards, a pointing device (e.g., a mouse or a trackball). Input from the user can be received in any form, including acoustic, speech, or tactile input. Moreover, feedback may be provided to the user via any form of sensory feedback (e.g., visual feedback, auditory feedback, or tactile feedback). A computer can interact with a user by sending documents to and receiving documents from a device that is used by the user (e.g., by sending web pages to a web browser on a user's client device in response to requests received from the web browser).

Embodiments of the subject matter described in this specification can be implemented in a computing system that includes one or more of the following components: a backend component (e.g., a data server); a middleware component (e.g., an application server); a frontend component (e.g., a client computer having a graphical user interface (“GUI”) and/or a web browser through which a user can interact with an implementation of the subject matter described in this specification); and/or combinations thereof. The components of the system can be interconnected by any form or medium of digital data communication, such as but not limited to, a communication network. Non-limiting examples of communication networks include a local area network (“LAN”) and a wide area network (“WAN”), e.g., the Internet.

The computing system may include clients and/or servers. The client and server may be remote from each other and interact through a communication network. The relationship of client and server arises by virtue of computer programs running on the respective computers and having a client-server relationship to each other.

Various embodiments are described in this specification, with reference to the detailed discussed above, the accompanying drawings, and the claims. Numerous specific details are described to provide a thorough understanding of various embodiments. However, in certain instances, well-known or conventional details are not described in order to provide a concise discussion. The figures are not necessarily to scale, and some features may be exaggerated or minimized to show details of particular components. Therefore, specific structural and functional details disclosed herein are not to be interpreted as limiting, but merely as a basis for the claims and as a representative basis for teaching one skilled in the art to variously employ the embodiments.

The embodiments described and claimed herein and drawings are illustrative and are not to be construed as limiting the embodiments. The subject matter of this specification is not to be limited in scope by the specific examples, as these examples are intended as illustrations of several aspects of the embodiments. Any equivalent examples are intended to be within the scope of the specification. Indeed, various modifications of the disclosed embodiments in addition to those shown and described herein will become apparent to those skilled in the art, and such modifications are also intended to fall within the scope of the appended claims.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

All references including patents, patent applications and publications cited herein are incorporated herein by reference in their entirety and for all purposes to the same extent as if each individual publication or patent or patent application was specifically and individually indicated to be incorporated by reference in its entirety for all purposes.

What is claimed is:

1. An apparatus comprising:
a plurality of heads each comprising a joint coupled to a rigid plate,
wherein the heads are spatially arranged such that the rigid plates of adjacent heads are directly or indirectly flexibly coupled, the rigid plates of the plurality of heads collectively creating a continuous surface.

2. An apparatus according to claim 1, further comprising:
one or more linear actuators, each linear actuator comprising a first end movably coupled to the joint of a corresponding head,
wherein operation of the one or more linear actuator(s) causes one or more corresponding head(s) to change a position and/or orientation relative to other heads by pivoting around adjacent edges between adjacent rigid plates.

3. An apparatus according to claim 1, further comprising a covering disposed on the rigid plates and coupled to the edges thereof.

4. An apparatus according to claim 3, wherein the covering is a flexible, high-density material.

5. An apparatus according to claim 3, wherein the covering is made substantially of rubber layer adhered to the rigid plates.

6. An apparatus according to claim 1, wherein each head can be inclined at about +45 degrees to about −45 degrees relative to an axis perpendicular to each said head.

7. An apparatus according to claim 1, wherein individual rigid plates are curved or flat.

8. An apparatus according to claim 1, wherein the continuous surface can be manipulated to be a substantially convex surface or a substantially concave surface.

9. An apparatus according to claim 1, wherein the topology of the continuous surface can be manipulated to create a substantially curved surface having a radius of at least one meter.

10. An apparatus according to claim 1, further comprising:
an attachment interface to allow the apparatus to be adjustably mounted to other objects; and
one or more actuators configured to change the position and/or orientation of the plurality of heads relative to the other objects.

11. A system comprising:
a plurality of heads each comprising a joint coupled to a rigid plate, wherein the heads are spatially arranged such that the rigid plates of adjacent heads are directly or indirectly flexibly coupled, the rigid plates of the plurality of heads collectively creating a continuous surface.

12. A system according to claim 11, further comprising:
one or more linear actuators, each linear actuator comprising a first end movably coupled to the joint of a corresponding head,
wherein operation of the one or more linear actuator(s) causes one or more corresponding head(s) to change a position and/or orientation relative to other heads by pivoting around adjacent edges between adjacent rigid plates.

13. A system according to claim 11, further comprising a covering disposed on the rigid plates and coupled to the edges thereof.

14. A system according to claim 13, wherein the covering is a flexible, high-density material.

15. A system according to claim 13, wherein the covering is made substantially of rubber layer adhered to the rigid plates.

16. A system according to claim 11, wherein each head can be inclined at about +45 degrees to about −45 degrees relative to an axis perpendicular to each said head.

17. A system according to claim 11, wherein individual rigid plates are curved or flat.

18. A system according to claim 11, wherein the continuous surface can be manipulated to be a substantially convex surface or a substantially concave surface.

19. A system according to claim 11, wherein the topology of the continuous surface can be manipulated to create a substantially curved surface having a radius of at least one meter.

20. A system according to claim 11, further comprising:
an attachment interface to allow the apparatus to be adjustably mounted to other objects; and
one or more actuators configured to change the position and/or orientation of the plurality of heads relative to the other objects.
